(19) United States
(12) Patent Application Publication
(10) Pub. No.: US 2011/0159215 A1
(43) Pub. Date: Jun. 30, 2011

(54) RECORDING MEDIUM

(75) Inventors: Kenichi Seguchi, Okaya-shi (JP); Ichiro Miyamoto, Osaka (JP); Masayuki Matsubara, Osaka (JP); Masayoshi Iwasaki, Osaka (JP); Hideyuki Uemura, Osaka (JP)

(73) Assignee: SEIKO EPSON CORPORATION, Tokyo (JP)

(21) Appl. No.: 12/952,995

(22) Filed: Nov. 23, 2010

(30) Foreign Application Priority Data
Nov. 26, 2009 (JP) 2009-268753

(51) Int. Cl. B41M 5/50; B41M 5/00

(52) U.S. Cl. 428/32.22

(57) ABSTRACT

The present invention relates to a recording medium containing: a transparent sheet containing a substrate and an ink-receiving layer formed thereon; and a release film that is attached to a substrate-side surface of the transparent sheet and is to be stripped of after image recording, in which the release film contains: a release film main body; and an adhesive layer that is disposed facing the substrate-side surface of the transparent sheet and is to be removed together with the release film main body when the release film is stripped off after image recording, and the adhesive layer defines an adhesive-free non-attachment region which is continuously present along a recording medium-conveying direction during image recording.

### TECHNICAL FIELD

The present invention relates to a recording medium comprising: a transparent sheet comprising a substrate and an ink-receiving layer formed thereon; and a release film which is attached to the substrate-side surface of the transparent sheet and is to be stripped off after image recording. More particularly, the invention relates to the recording medium in which the release film is stripped off without leaving an adhesive residue on the transparent-sheet side, is less apt to peel off during feeding/conveyance of recording medium in image recording, and can be easily stripped off after image recording.

### BACKGROUND ART

Ink-jet recording is a technique for image recording in which minute ink droplets are ejected by means of any of various operating theories and adhered onto a recording medium, e.g., paper, a film or sheet, etc. The ink-jet recording technique is in extensive use in terminal printers, facsimile telegraphs, plotters, document printing, and the like because this recording technique produces little noise, readily accommodates multicolor recording such as full-color image formation, is capable of high-speed recording, and has other advantages including a lower recording cost than in other printing devices.

As a result of improvement in resolution and in the range of reproducible colors, the ink-jet recording technique has become capable of forming recorded images which compare favorably with printed images formed by multicolor printing using printing plates or by color photography, Consequently, there recently is a rapidly growing demand to use the ink-jet recording technique in design applications where high coloring properties and color reproducibility are required, such as posters, displays, leaflets, and package proofs.

Patent Document 1: JP-A-2009-95991

Patent Document 2: JP-A-2003-76308

Patent Document 3: JP-A-2008-248035

Patent Document 4: JP-A-2004-226547

Patent Document 5: JP-A-2002-99215

Patent Document 6: JP-A-2002-32022

Patent Document 7: JP-A-2009-78475

Patent Document 8: JP-A-2007-99797

Non-Patent Document 1: The Adhesion Society of Japan, “Interface between Object and Object . . . Adhesion and Pressure-Sensitive Adhesion”, [online], [retrieved on Sep. 28, 2009], Internet, <URL:

http://www.oct.zaq.ne.jp/kansai/2211_psa_tape.html>

### SUMMARY OF THE INVENTION

Meanwhile, in the case where printing on recording media is conducted by means of an image-recording apparatus of the ink-jet type or the like, whether a recording medium is present in the conveyance line or not is generally determined with an optical sensor or the like. Namely, an optical sensor emits light toward the conveyance line for recording media, and whether a recording medium is present or not is determined based on detection of reflected light (see patent document 1).

However, in the case of transparent recording media, there is a problem that the recording media transmit light and are hence difficult to be detected by means of an optical sensor. Furthermore, transparent recording media have drawbacks that scratches and smudges of the ink-receiving layer are apt to be conspicuous in comparison to those of paper, Especially in the case of an elongated recording medium, this recording medium is stored/distributed in a roil form, and hence, the ink-receiving layer is in contact with the substrate serving as the back surface of the recording medium, resulting in an increased frequency of the occurrence of scratches or smudges.

Consequently, for mitigating those problems, it is desirable that a transparent recording medium should comprise a transparent sheet obtained by forming an ink-receiving layer on a substrate and a release film laminated on the substrate-side surface of the transparent sheet, even when the transparent recording medium is not for use as a label in which the recording medium per se has a pressure-sensitive adhesive layer formed thereon, as described in, for example, patent documents 2 to 6. This release film is used only for the purpose of making the reflectance detectable with an optical sensor, protecting the ink-receiving layer, or preventing adhesion thereof, and is stripped off after printing. The release film is hence required to be capable of being stripped off without leaving any adhesive residue on the transparent-sheet side.

Adhesives used for bonding the transparent sheet to the release film include those of a pressure-sensitive adhesion type and an adhesion type.

As described in non-patent document 1, an adhesive of the adhesion type is an adhesive which, in the initial stage where the adhesive is contacted with an adherend, is a flowable, liquid and is capable of readily wetting the adherend, and which thereafter changes into a solid through a chemical reaction, heating, solvent volatilization, temperature change, etc. to constitute a strong bonding at the interface and exhibit an ability that resists peeling (see, for example, patent documents 7 and 8). On the other hand, an adhesive of the pressure-sensitive adhesion type is an adhesive which is a semisolid (gel state) having high-viscosity and low-modulus from the initial stage where the adhesive is contacted with an adherend, and which adhesive in this state wets the adherend, undergoes no change in the state even after constituting a bonding, and exhibits an ability that resists peeling (see, for example, patent document 3). Adhesives of the pressure-sensitive adhesion type are characterized by being flexible and applied thick so that peeling stress is dispersed in the pressure-sensitive adhesive layer.

However, in the case where printing on a large recording medium (e.g., A2-size medium) for producing, for example, an advertising poster is conducted, there have been the following problems. When the release film is attached to the transparent sheet with an adhesive of the pressure-sensitive adhesion type, there is a fear that the printed matter is contaminated in the stripping step by a worker since the adhesive layer formed on the release film may come again into contact with the substrate-side surface of the transparent sheet or come into contact with the image-bearing surface of the transparent sheet, On the other hand, when the release film is attached to the transparent sheet with an adhesive of the adhesion type, the release film has improved handleability in the stripping step since the adhesive layer of this release film has been solidified and no longer has adhesive strength. However, unlike the adhesive of the pressure-sensitive adhesion type, the adhesive of the adhesion type has a relatively small thickness of adhesive layer. There has been hence a problem that stripping is hardly carried out for the worker by inserting one's finger into the layer interface. In addition, adhesives of the adhesion type are difficult to adjust the adhesive strength. Specifically, too high adhesive strength makes it difficult to strip off the release film, On the other hand, in case where adhesive strength is excessively reduced in order to facilitate stripping, the release film undesirably peels off during feeding/conveyance of the recording medium in a printer. This peeling has been a cause of printing troubles.

Accordingly, an object of the invention is to provide a recording medium including a release film which is stripped off without leaving any adhesive residue on the transparent-sheet side, is less apt to peel off during feeding/conveyance of recording-medium in image recording, and can be easily stripped off after image recording.

In order to accomplish the above object, the invention relates to the followings.

The recording medium of the invention comprising:

a transparent sheet comprising a substrate and an ink-receiving layer formed thereon; and

a release film that is attached to the substrate-side surface of the transparent sheet and is to be stripped off after image recording,

wherein the release film comprises:

a release film main body; and

an adhesive layer which is disposed facing the substrate-side surface of the transparent sheet and is to be removed together with the release film main body when the release film is stripped off after image recording, and

the adhesive layer defines an adhesive-free non-attachment region which is continuously present along a recording medium-conveying direction during image recording.

In the case where the recording medium is an elongated recording medium, this recording medium has the adhesive-free non-attachment region in the release film disposed so as to be present continuously along the lengthwise direction of the elongated recording medium.

According to the above-mentioned recording medium, regardless of whether the recording medium is an elongated sheet or a cut sheet, an adhesive-free portion is formed in each conveying direction end part of the recording medium. Especially when the recording medium is an elongated sheet, cutting the sheet perpendicularly to the conveying direction can always give an adhesive-fret portion in the cut surface. Consequently, the worker can form a space between the transparent sheet and the release film by bending the recording medium in preparation for stripping, with the release film facing inward, and lift up the adhesive-free portion of release film. Thus, the worker can easily strip off the release film with one's fingers.

Furthermore, in the case of forming an adhesive layer using an adhesive of the adhesion type, it has hitherto been necessary to suppress the adhesive strength thereof because this adhesive layer has a smaller thickness than adhesive layers formed by the pressure-sensitive adhesion type adhesive and it is difficult for the worker to strip off the release film with one's finger inserted into the layer interface. However, the configuration described above facilitates the stripping operation arid, hence, the adhesive strength can be set high. As a result, the release film is inhibited from peeling off during feeding/conveyance of recording-medium in an image-recording apparatus, and printing troubles can be avoided.

Especially, in the case where the recording medium is an elongated sheet, the non-attachment region is present in an area other than both peripheral parts along the lengthwise direction of the recording medium.

In this recording medium, the adhesive-free non-attachment region is present in an area other than both peripheral parts along the lengthwise direction of the recording medium. Namely, both peripheral parts in any cut surface cut perpendicular to the conveying direction are always in the state of being attached with the adhesive, Consequently, the release film can be prevented from peeling off during feeding/conveyance of the recording medium in an image-recording apparatus.

Especially, in the ease where the recording medium is a cut sheet, and the non-attachment region is present in an area other than the four corners of the recording medium.

In this recording medium, the adhesive-free non-attachment region is present in an area other than the four corners. Namely, both conveying direction end parts are always in the state of being attached with the adhesive. Consequently, the release film can be prevented from peeling off during feeding/conveyance of the recording medium in an image-recording apparatus.

Further, in the recording medium, the adhesive layer has been attached to the substrate of the transparent sheet preferably by solidifying a composition for forming the adhesive layer, while bringing the composition into contact with the substrate-side surface of the transparent sheet.

According to this recording medium, the adhesive layer is solidified. Therefore, even in the case where a recording medium having a large size (e.g., A2 size) is printed for producing an advertising poster or the like, the printed matter is not contaminated in the step of stripping off the release film, In the case where the adhesive layer is formed by an adhesive of the adhesion type as conventional techniques, it was necessary to control the adhesive strength thereof at low in order to enhance strippability since the adhesive layer formed by an adhesive of the adhesion type has a smaller thickness than that formed by an adhesive of the pressure-sensitive adhesion type and it is difficult for the worker to strip off the release film with one's finger inserted into the layer interface. However, according to the invention, since the adhesive layer is formed so that the adhesive-free non-attachment region is continuously present along the direction of conveyance during image recording, the stripping operation is facilitated and, hence, the adhesive strength can be set high. As a result, the release film is inhibited from unexpectedly peeling off during feeding/conveyance of recording medium in an image-recording apparatus, and printing troubles can be avoided.

In the above mentioned recording medium, the substrate of the transparent sheet preferably comprises a material selected from the group consisting of polyethylene terephthalate (PET), biaxially stretched polypropylene (OPP), and polypropylene (PP).

According to this recording medium, the transparent sheet exhibits some properties of not only being transparent, but also rigidity which enables the recording medium to withstand ordinary ink-jet image-recording processes. In addition, the adhesive layer can be more stably formed thereon than on paper, fabrics, and the like.

The above mentioned recording medium can be advantageously used in ink-jet recording.

### BRIEF DESCRIPTION OF THE DRAWINGS

FIG. 1 is a schematic sectional view of an elongated ink-jet recording medium 10 as one embodiment of the invention, in which the recording medium 10 is cut perpendicularly to the lengthwise direction.

FIG. 2 (a) and FIG. 2 (b) are plan views illustrating examples of the adhesive layer 3 of an elongated ink-jet recording medium 10.

FIG. 3 is a schematic view illustrating the step of stripping off the release film 12 of an elongated ink-jet recording medium 10, in which the elongated ink-jet recording medium 10 is cut out and bent with the release film 12 facing inward.

FIG. 4 is a plan view illustrating an example of the adhesive layer 13 of a cut-sheet-form ink-jet recording medium 20 as another embodiment of the invention.

### DESCRIPTION OF REFERENCE NUMERALS AND SIGNS

1: substrate
2: ink-receiving layer
3, 13: adhesive layer
4: release film main body
5, 15: non-attachment region
6: peripheral part
7: adhesive-free portion
10: elongated ink-jet recording medium
11: transparent sheet
12: release film
16: corner (end part)
20: cut-sheet-form inkjet recording medium
D, E, F. conveying direction.

### MODE FOR CARRYING OUT THE INVENTION

The following will describe the recording medium of the invention in detail. The embodiments described below are preferred examples of the invention and hence include various technically preferred limitations. However, the scope of the invention should not be construed as being limited to the embodiments unless there is a particular statement below which limits the invention.

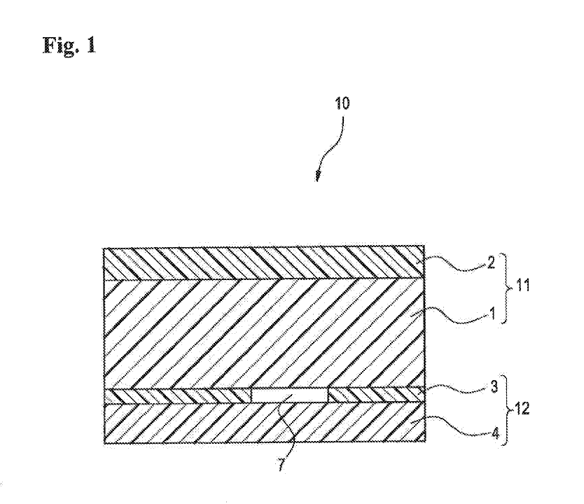

FIG. 1 is a schematic sectional view of an elongated inkjet recording medium 10 (hereinafter also referred to simply as “recording medium 10”) as one embodiment of the invention, in which the recording medium 10 is cut perpendicularly to the lengthwise direction.

As shown in FIG. 1, the recording medium 10 is configured so as to include: a transparent sheet 11 comprising a substrate 1 and an ink-receiving layer 2 formed thereon; and a release film 12 which is attached to the substrate I side of the transparent sheet 11 and is to be stripped off after image recording, The release film 12 comprises: a release film main body 4; and an adhesive layer 3 laminated on the release film main body 4, wherein the adhesive layer 3 is disposed on opposite the substrate 1-side surface of the transparent sheet 11 and is to be removed together with the release film main body 4 when the release film 12 is stripped off after image recording. Also as shown in FIG. 1, the release film has the adhesive layer formed so that an adhesive-free non-attachment region 5 (hereinafter referred to as “non-attachment region 5) is continuously present along the direction (lengthwise direction) in which the recording medium 10 is conveyed during image recording. Consequently, the cut surfaces perpendicular to the lengthwise direction have an adhesive-free portion 7 as shown in FIG. 1. Incidentally, in the case. where the elongated recording medium is wound into a roll, the lengthwise direction means the direction in which the recording medium is wound into the roll.

A material of the substrate 1 is not particularly limited. Examples thereof include transparent substrates such as films of synthetic resins, e.g., polyesters, polyolefins, and polyvinyl chloride. It is preferred in the invention that the substrate 1 comprises a material selected from the group consisting of polyethylene terephthalate (PET), biaxially stretched polypropylene (OPP), and polypropylene (PP) from the standpoints of ensuring transparency and rigidity and of the adhesion stability of the adhesives. The suitability of the substrate 1 for coating with the ink-receiving layer 2 can be improved by subjecting the substrate 1 to a surface treatment such as corona discharge treatment. Although the thickness of the substrate 1 is not particularly limited, the thickness thereof is preferably in the range of 25-400 μm. When suitability for mounting on printers and handleability are taken into account, the thickness thereof is preferably 50-300 μm.

The kind of the ink-receiving layer 2 in the invention and methods for forming the layer are not particularly limited, Examples of materials usable for forming the ink-receiving layer 2 include polyvinyl alcohol, polyvinylpyrrolidone, starch, water-soluble cellulose, urethane resins, acrylic resins, crosslinking agents, and fillers. Examples of methods for forming the layer include techniques using an air-knife coater, roll coater, blade coater, rod metering coater, comma coater, curtain coater, or the like. The thickness of the ink-receiving layer 2 is preferably 5-50 μm, more preferably 10-30 μm, from the standpoint of absorbing properties. However, the thickness thereof is not limited to these ranges.

The release film main body 4 in the invention is not particularly limited. However, it is desirable that the release film main body 4 comprises a material equivalent to that of the substrate so that the thermal expansion which occurs due to the environment for storage does not result in a difference in expansion/shrinkage.

The adhesive layer 3 may be either the adhesion type or the pressure-sensitive, adhesion type. However, the adhesive layer 3 preferably is of the adhesion type, The adhesive layer 3 of the adhesion type has an advantage that since the adhesive layer 3 has been solidified, there is a lower possibility, than in the case of the pressure-sensitive adhesion type, that even when the recording medium having a large size (e.g., A2 size) for an advertising poster or the like is printed, the surface of the release film stripped off in the stripping step might contaminate the printed matter when the surface thereof comes into contact with the printed portions. Furthermore, the release film main body 4 in the non-attachment region 5 is in the state of lifting up without being attached to the substrate 1, as will be described later. However, the adhesive layer 3 of the adhesion type can accomplish a reduced layer thickness and, hence, the lifting can be made smaller. As a result, the lifting poses no problem when the recording medium is fed to a printer. It is preferred that the adhesive layer 3 has been attached to the substrate 1 of the transparent sheet 11 by solidifying a composition for forming the adhesive layer 3, in a manner such that the composition is in the state of contacting with the substrate 1-side surface of the transparent sheet 11, and is solidified by means of a chemical reaction, solvent volatilization, or heating. Incidentally, the adhesive layer 3 may be disposed directly on the substrate 1 as shown in FIG. 1, or disposed on another layer that is disposed on the side of the substrate I which faces the adhesive layer 3. Examples of the kinds of materials usable for forming the adhesive layer 3 include polyurethane resin hot-melt adhesives and polyolefin resin hot-melt adhesives.

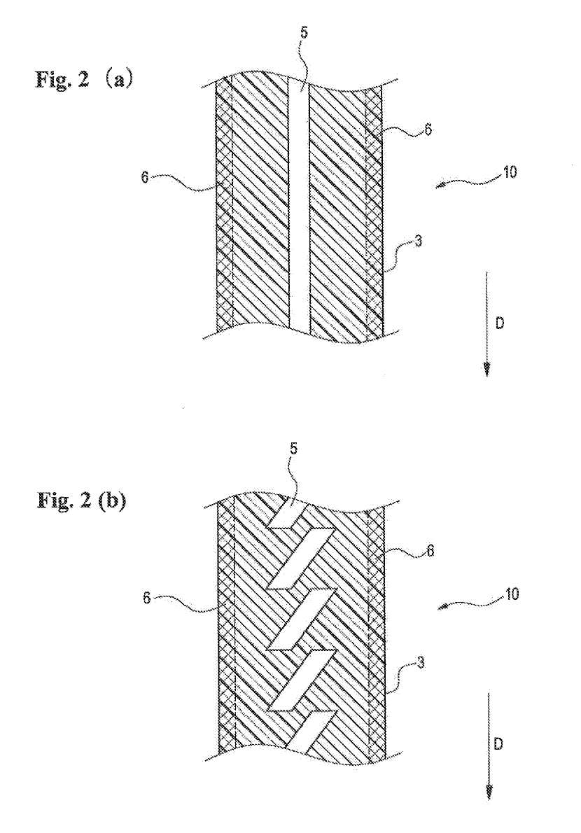

FIG. 2 (a) and FIG. 2 (b) are plan views illustrating examples of the adhesive layer 3 of an elongated ink-jet recording medium 10.

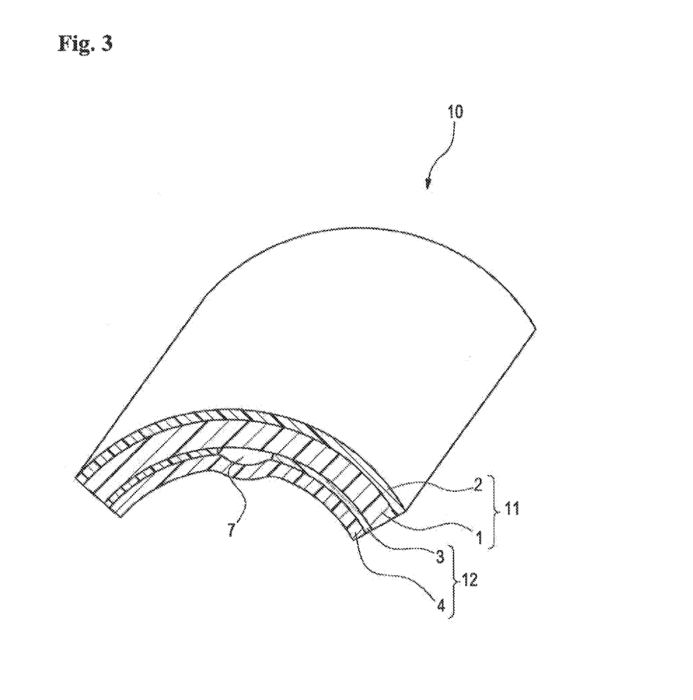

As shown in FIG. 2 (a), the adhesive layer 3 defines a non-attachment region 5 which is linearly and continuously present along the conveying direction D during image recording (lengthwise direction of the recording medium 10). The adhesive layer 3 may have a pattern formed by consecutively arranging a plurality of non-attachment regions 5 in the conveying direction D, as shown in FIG. 2 (b). As a result of these configurations, when the recording medium is cut perpendicularly to the conveying direction D, the resultant cut surfaces of the sheet always have an adhesive-free portion 7 as shown in FIG. 1. Consequently, when a worker cuts the elongated ink-jet recording medium 10 into a desired size and is to strip off the release film 12, the worker can lift up the adhesive-free portion 7 to form a space between the transparent sheet 11 and the release film 12, by bending the ink-jet recording medium 10 with the release film 12 facing inward as shown in FIG. 3, even when the adhesive layer 3 has high adhesive strength and a small layer thickness. Thus, the worker can easily strip off the release film 12 with one's fingers.

It is desirable that the non-attachment region 5 should be present in an area other than both peripheral parts 6 along the lengthwise direction of the recording medium 10, Namely, both peripheral parts 6 in any cut surface cut perpendicular to the conveying direction D are always in the state of being attached with the adhesive. Consequently, the release film can be prevented from peeling off during feeding/conveyance of the recording medium in an image-recording apparatus.

For forming the adhesive layer 3, use can be made of various known coaters such as an air-knife coater, roll coater, blade coater, rod metering coater, comma coater, and curtain coater, In the case of forming the adhesive layer 3 by printing, use can be made of various known printing machines such as a letterpress printing machine, gravure printing machine (intaglio printing machine), screen printing machine, and offset printing machine. For example, in the case where printing is conducted with a gravure printing machine, an adhesive layer 3 can be formed on a release film main body 4 by winding a film on a portion of a roll which corresponds to the non-attachment region 5 so that the adhesive composition is prevented from being held on that portion. Use of a printing machine has advantages that an adhesive layer 3 having an especially even thickness can be obtained and that the kind and amount of the adhesive composition for forming an adhesive layer 3 and the position where the non-attachment region 5 is to be formed can be easily and rapidly changed. The thickness of the adhesive layer 3 is preferably 0.5-10 μm because surface irregularities due to the difference in level between the attachment region and the non-attachment region can be made smaller.

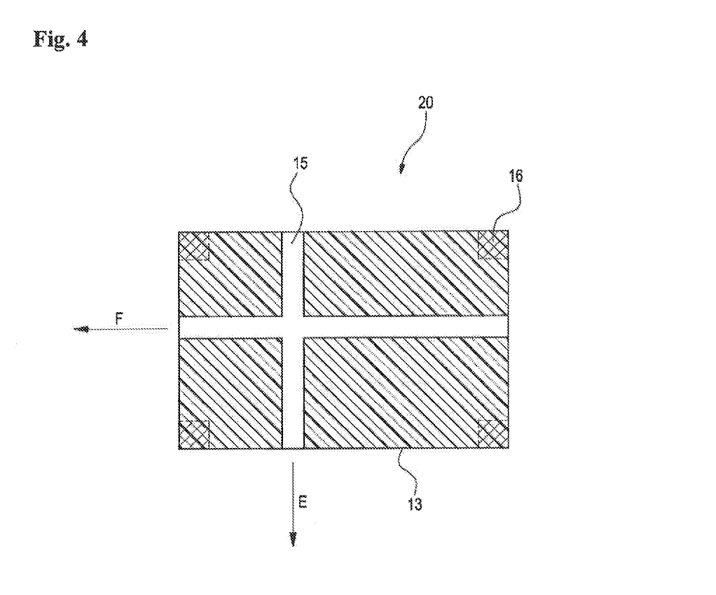

FIG. 4 is a plan view illustrating an example of the adhesive layer 13 of a cut-sheet-form ink-jet recording medium 20 (hereinafter also referred to simply as “recording medium 20”) as another embodiment of the invention. The conveying direction of the recording medium 20 can be suitably set by a user. Therefore, the adhesive layer 13 is formed so that the non-attachment region 15 is continuously present in each of the conveying directions (conveying directions E and F) as shown in FIG. 4, Namely, an adhesive-free portion is present in each of the four sides of the recording medium 20. The non-attachment region 15 is present in an area other than the four corners of the recording medium 20. As a result of this configuration, both end parts 16 are always attached with the adhesive regardless of whether the conveying direction is E or F. Consequently, the release film can be prevented from peeling off during feeding/conveyance of the recording medium in an image-recording apparatus.

While the invention has been described in detail and with reference to specific embodiments thereof, the invention should not be construed as being limited to the aforementioned embodiments or examples, and modifications, changes and the like can be made therein accordingly.

The present application is based on Japanese Patent Application No. 2009-268753 filed on Nov. 26, 2009, and the contents thereof are incorporated herein by reference.

What is claimed is:

1. A recording medium comprising:
a transparent sheet comprising a substrate arid an ink-receiving layer formed thereon; and
a release film that is attached to a substrate-side surface of the transparent sheet and is to be stripped off after image recording,
wherein the release film comprises:
a release film main body; and
an adhesive layer that is disposed facing the substrate-side surface of the transparent sheet and is to be removed together with the release film main body when the release film is stripped off after image recording, and
the adhesive layer defines an adhesive-free non-attachment region which is continuously present along a recording medium-conveying direction during image recording.

2. The recording medium according to claim 1, wherein the recording medium is an elongated sheet and the non-attachment region is present in an area other than both peripheral parts along the lengthwise direction of the recording medium.

3. The recording medium according to claim 1, wherein the recording medium is a cut sheet and the non-attachment region is present in an area other than the four corners of the recording medium.

4. The recording medium according to claim 1, wherein the adhesive layer has been attached to the substrate of the transparent sheet by solidifying a composition for forming the adhesive layer while bringing the composition into contact with the substrate-side surface of the transparent sheet.

5. The recording medium according to claim 1, wherein the substrate of the transparent sheet comprises a material selected from the group consisting of polyethylene terephthalate (PET), biaxially stretched polypropylene (OPP), and polypropylene (PP).

6. The recording medium according to claim 1, which is for use in ink-jet recording.

7. An elongated recording medium comprising:
a transparent sheet comprising a substrate and an ink-receiving layer formed thereon; and
a release film that is attached to the substrate-side surface of the transparent sheet and is to be stripped off after image recording,
wherein the release film comprises:
a release film main body; and
an adhesive layer that is disposed facing the substrate-side surface of the transparent sheet and is to be removed together with the release film main body when the release film is stripped off after image recording, and
the adhesive layer defines an adhesive-free non-attachment region which is continuously present along a lengthwise direction of the elongated recording medium.
